(19) United States
(12) Patent Application Publication
(10) Pub. No.: US 2010/0238923 A1
(43) Pub. Date: Sep. 23, 2010

(54) TUNNELING METHOD OF MOBILE TERMINAL FOR SUPPORTING IP MOBILITY

(75) Inventors: Kyung-Yul Cheon, Daejon (KR); Hyeyeon Kwon, Daejon (KR); Ae-Soon Park, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignees: Electronics and Telecommunications Research Institute, Daejeon (KR); KTFREETEL CO., LTD., Seoul (KR)

(21) Appl. No.: 12/515,209

(22) PCT Filed: Oct. 30, 2007
(86) PCT No.: PCT/KR2007/005383

§ 371 Date: May 15, 2009

(30) Foreign Application Priority Data
Nov. 16, 2006 (KR) 10-2006-0113130

(51) Int. Cl. H04L 12/56

(52) U.S. Cl. 370/389

(57) ABSTRACT

A tunneling method for a mobile terminal is provided. In the tunneling method, a first device driver connected to a visit network senses a packet tunneled to an interface connected to the visit network, and the first device driver decapsulates a packet without transmitting the packet to a first IP end that is an upper layer of the first device driver and transmits the decapsulated packet to a second driver. Then, the second driver transmits a packet to a second IP end that is an upper layer of the second driver.

### TECHNICAL FIELD

The present invention relates to a tunneling method for a mobile terminal when the mobile terminal uses a mobile Internet protocol (IP) for guaranteeing the IP mobility of a mobile terminal; and, more particularly, to a tunneling method for a mobile terminal in order to embody the tunneling of a mobile terminal by processing packet at a device driver such as a network driver when a mobile IP is used for supporting the IP mobility of a mobile terminal having a closed-source operating system.

This work was partly supported by the Information Technology (IT) research and development program of the Korean Ministry of Information and Communication (MIC) and/or the Korean Institute for Information Technology Advancement (IITA) [2005-S-404-32, “Research & development on Mobile Terminal Technology based on 3G Evolution”].

### BACKGROUND ART

FIG. 1 is a diagram illustrating a fundamental model of a mobile IP that guarantees the Internet protocol (IP) mobility of a mobile terminal.

In general, a mobile IP is a technology to guarantee the IP mobility of a mobile node 102. In the mobile IP, a mobile node 101 registers the location thereof to a home agent (HA) 102 when the mobile mode 101 moves, and the home agent 102 performs a tunneling process to transfer packets to the mobile node at a corresponding location.

Accordingly, the mobile node 101 is enabled to continuously communicate with a corresponding node 103 using a home address which was used in a home network 104 although the mobile node 101 is in a visit network 105. In this case, the mobile node 101 has to directly generate a tunnel to transmit a packet to the home agent (HA) 102 when the mobile node 101 uses a mobile IPv6 and a collocated-care-of-address (CCoA) type of a mobile IPv4.

In tunneling methods according to the related art, an IP end generally performs a tunneling process. The tunneling methods according to the related art are classified into two types according to whether the source of an operating system are opened or closed.

In case of an opened-source operating system such as Linux, an IP end inspects packets. If the IP end detects a tunneled packet, the IP end decapsulates a packet and transmits the packet directly to the other IP end.

In case of a closed-source operating system such as MS-Windows, packets of an IP end are captured at a user level because an IP end cannot directly process the packet, tunneled packets among the captured packets are decapsulated, and the decapsulated packet is transmitted to the other IP end. A packet is also transmitted through a tunnel by the same operating structure.

Since the IP packets are directly captured and processed at a user level in the closed-source operating system, the large amount of system load is generated and it is ineffective in a view of a processing speed.

### DISCLOSURE OF INVENTION

### Technical Problem

An embodiment of the present invention is directed to providing a tunneling method for a mobile terminal in order to embody the tunneling of a mobile terminal by processing packet at a device driver such as a network driver when a mobile IP is used for supporting the IP mobility of a mobile terminal having a closed-source operating system.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a tunneling method for a mobile terminal, including: at a first device driver connected to a visit network, sensing a packet tunneled to an interface connected to the visit network; at the first device driver, decapsulating a packet without transmitting the packet to a first IP end that is an upper layer of the first device driver and transmitting the decapsulated packet to a second driver; and at the second driver, transmitting a packet to a second IP end that is an upper layer of the second driver.

In accordance with another aspect of the present invention, there is provided a tunneling method for a mobile terminal including: at a second device driver with a home address is mapped, receiving an IP packet using a home address; at the second device driver, transferring the received packet to a first device driver mapped to a current tunneling end point; and at the first driver, encapsulating the received packet and transmitting the encapsulated packet to an interface that is a lower layer of the first driver.

### Advantageous Effects

According to a tunneling method for a mobile terminal of the present invention, a device driver such as a network driver processes packets for embodying tunneling when a mobile terminal has a closed-source operating system. Therefore, the system load for tunneling can be reduced, and the tunneling can be effectively embodied in a view of a processing speed.

In case of a mobile IP is used for supporting the IP mobility of a mobile terminal having a closed-source operating system, a device driver such as a network deriver processes packets to embody the tunneling of a mobile terminal. Therefore, the tunneling can be effectively and flexibly embodied in the views of the processing speed and the system load.

### BRIEF DESCRIPTION OF THE DRAWINGS

FIG. 1 is a diagram illustrating a fundamental model of a mobile IP for guaranteeing IP mobility of a mobile terminal.

FIG. 2 is a block diagram showing a protocol stack and packet flow for tunneling in a mobile terminal in accordance with an embodiment of the present invention.

FIG. 3 is a diagram depicting a protocol stack and packet flow in a home network of a mobile terminal in accordance with an embodiment of the present invention.

FIG. 4 is a flowchart of an IP activation algorithm of each device according to whether a mobile terminal moves to a home network or a visit network in accordance with an embodiment of the present invention.

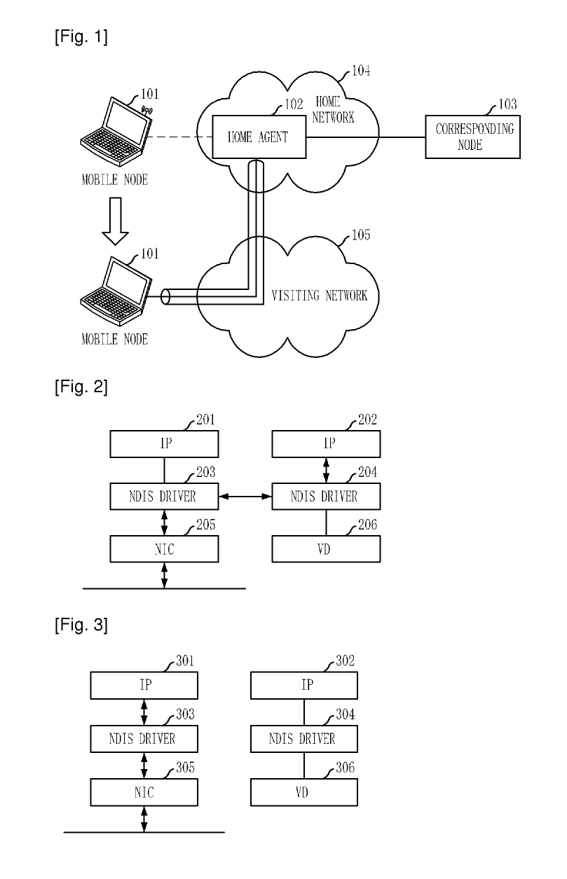

### BEST MODE FOR CARRYING OUT THE INVENTION

The advantages, features and aspects of the invention will become apparent from the following description of the embodiments with reference to the accompanying drawings, which is set forth hereinafter.

Hereinafter, a tunneling method for a mobile terminal having a closed-source operating system will be described with reference to accompanying drawings. Also, a protocol structure and an operating method that enable the application program of a mobile terminal to receive a service using an invariable IP address will be described.

FIG. 2 is a block diagram illustrating a communication protocol stack and packet flow for tunneling in a mobile terminal in accordance with an embodiment of the present invention.

Device drivers, a lower layer of an IP layer, generally provide a kennel function level of an application program interface (API) to a user for the comparability of new hardware in a closed-source operating system. Therefore, a further effective tunneling method may be provided using network device interface specifications (NDIS) 203 and 204 which are related to a predetermined network device.

As shown in FIG. 2, the protocol stack includes a network interface card 205 and a virtual device (VD) 206 which denote a common network device which is a first layer, NDIS drivers 203 and 204 which are a second layer, and a home address IP 202 of a mobile terminal and a care-of-address (CoA) 201 obtained from a visit network, which are a third layer.

When a mobile terminal moves to a visit network 105, the IP layer 202 of the virtual device 206 must allocate the home address of the mobile terminal, and an application program is always operated based on the allocated home address.

In the present embodiment, tunnel for packets received at a mobile terminal is embodied as follows.

In order to transmit and receive packets through tunneling, it necessary to obtain tunneling information that is information about IP addresses of a tunneling internal header and a tunneling external header, such as IP addresses of a receiver and a transmitter, which are an object of performing tunneling. The tunneling information may be assigned by a user manually, or may be set through the signal exchange of a protocol related to the tunneling. In case of using a mobile IP, a binding list may be used to obtain the tunneling information.

At first, the NDIS driver 203 senses a tunneled packet when the NIC 205 receives the tunneled packet, which is a network interface connected to the visit network 105.

It is determined whether the received packet is a packet encapsulated by applying tunneling like IP-in-IP or not by inspecting the IP header of the received packet. And, it is also determined whether an IP address in an external header of the tunneled IP packet is included in tunneling information or not.

If the IP address of the external header is included in the tunneling information, the NDIS driver 203 connected to the visit network 105 decapsulates the received packet without transmitting the packet to the upper level IP end 201.

Then, the NDIS driver 203 confirms a receiver address in the decapsulated packet and directly transmits the received packet to the NDIS driver 204 that is mapped to a corresponding address.

Herein, the packet is transmitted as follows. That is, the packet is directly forwarded to the opponent NDIS driver 204 through copying a memory or transferring a memory address, the packet is transmitted to the opponent NDIS driver 204 through calling a packet transmission function of the opponent NDIS driver 204, or the packet is directly transmitted to the opponent IP end 202 by calling the packet transmission function of the opponent IP end 202.

The decapsulation process may simply remove a header when the received packet is an IP-in-IP type packet that is tunneled through IP-in-IP tunneling. Also, the decapsulation process may be a decoding process using security association when the received packet is an IP security protocol type (IPsec) packet which is tunneled through an IP security protocol.

In case of using a mobile IP, binding list information is generated while the mobile IP protocol operates and the biding list information includes the addresses of a transmitter and a receiver of a tunnel external header and the address of a receiver of an internal header. In other word, the binding list of the mobile IP includes a home address, a home agent (HA) address, a care-of-address, and a life time. The home address for the received tunneling packet is the IP address of a receiver in a tunneling internal header. The care-of-address is the address of a receiver in the tunneling external header, and the HA address is a transmitter's IP address of the tunneling external header. Since the transmitter's IP address in the tunneling internal header may be an IP address of a corresponding node that transmits the packet, it is not necessary to store the transmitter's IP address of the tunneling internal header in case of the tunneling used in the mobile IP.

Then, the NDIS driver 204 mapped to the receiver's address transmits packets to the upper level IP end 202.

That is, the NDIS driver 204 calls a packet transmission function with a memory address of a packet and transmits a packet to the upper level IP end 202 as the packet transmitting/receiving process of a general network protocol that is managed in an operating system.

If tunneling is established, a mobile terminal can transmit a packet in a form of a tunneling packet through encapsulation. A mobile IP is equivalent to reverse-tunneling. A mobile terminal such as mobile node performs tunneling for transmitting a packet to an external device such as a corresponding node as follows.

At first, an IP end 202 transmits an IP packet, which is transmitted from an application program using a home address, to a NDIS driver 204 mapped with the home address according to an IP protocol driving mechanism of a general operating system.

Then, the NDIS driver 204 mapped with the home address transmits the received packet to a NDIS driver 204 mapped with a current tunneling end point.

Herein, a method of determining whether tunneling is performed or not, a method of forming tunneling, and a method of finding a NDIS driver 203 mapped with a tunneling end point use the above described tunneling information. That is, the IP header of a transmitting packet is inspected, and tunneling is performed if the tunneling information includes the addresses of a transmitter and a receiver. As the addresses of a transmitter and a receiver of a tunneling external header, an IP address recorded in the tunneling information is used. Then, the NDIS driver 204 transmits packets to the NDIS driver 203 mapped with the address of a transmitter in the tunneling external header.

In case of using a mobile IP, a mobile terminal is connected to a corresponding node through a home agent. That is, the mobile terminal and the home agent is not 1:1 tunneling relation. A mobile node must form tunneling for transmitting packets with a home address as an IP address of a transmitter. Herein, binding list information, which is generated while the mobile IP operates, is used. All of packets from an IP end 202 mapped with a home address become the object of tunneling regardless of a transmitter. An IP address of a transmitter in a tunneling external header is used as the care-of-address, and an IP address of a receiver in a tunneling internal header is used as the HA address.

Then, the NDIS driver 203 mapped with the current tunneling end point encapsulates a received packet and transmits the encapsulated packet to an external device through a lower level NIC 205.

Herein, the packet is transmitted as follows. That is, the packet is directly forwarded to the corresponding NDIS driver 203 through copying a memory or transferring a memory address, the packet is transmitted to the corresponding NDIS driver 203 through calling a packet transmission function of the corresponding NDIS driver 203, or the packet is directly transmitted to a corresponding NIC end 205 by calling the packet transmission function of the corresponding NIC end 205.

The encapsulation process may be a process of simply adding a header when a packet is an IP-in-IP type packet. The encapsulation process may be an encoding process using security association if a packet is an IP security protocol type packet.

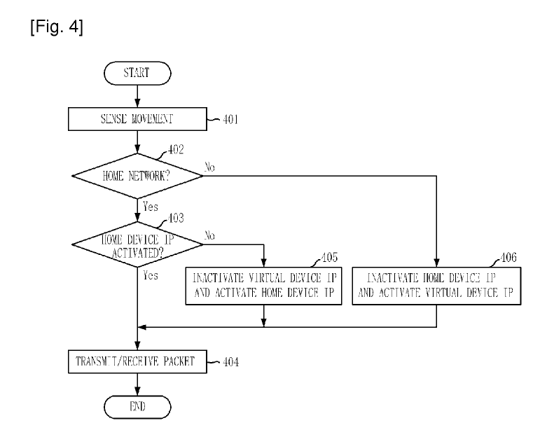

FIG. 3 is a diagram illustrating a protocol stack and packet flow in a home network of a mobile terminal, and FIG. 4 is a flowchart illustrating an IP activation algorithm of each device according to whether a mobile terminal moves to a home network or a visit network in accordance with an embodiment of the present invention. That is, FIG. 4 shows a method of allocating and releasing a home address of a terminal to an IP address of a device and an IP address of a virtual device connected to a home network according to whether a mobile terminal moves to a home network or a visit network.

Referring to FIGS. 3 and 4, when a mobile terminal moves at step S401, the mobile terminal determines whether a network currently connected to the mobile node is a home network or a visit network at step S402. If the mobile terminal determines that the currently connected network is the home network, the mobile terminal allocates a home address to an IP layer 301 of a device connected to the home network and independently operates without driving a virtual device as shown in FIG. 3. That is, if the mobile terminal determines that the currently connected network is the home network, the mobile terminal determines whether the IP layer 301 of a device connected to the home network is activated or not at step S403. If the mobile terminal determines that the IP layer 301 is activated at step S403, the mobile terminal transmits and receives packet without additional processes at step S404.

If the mobile terminal determines that the IP layer 301 of the device connected to the home network is not activated and the IP layer 302 of the virtual device 305 is activated by the home address allocated thereto at step S403, the IP layer 302 of the virtual device 305 is inactivated at step S405 and the mobile terminal transmits and receives packets at step S404.

If the mobile terminal determines that the mobile terminal is connected to the visit network at step S402, the mobile terminal allocates a home address to an IP layer 302 of the virtual device 305 and activates the IP layer 302 of the virtual device 305. If an home address is previously allocated to a device connected to a home network, the mobile terminal inactivates the IP layer 301 of the home device 3 and transmits and receives packets at step S404.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean Patent Application No. 10-2006-0113130, filed in the Korean Intellectual Property Office on Nov. 16, 2006, the entire contents of which is incorporated herein by reference.

While the present invention has been described with respect to certain preferred embodiments, it will be apparent to those skilled in the art that various changes and modifications may be made without departing from the spirits and scope of the invention as defined in the following claims.

1. A tunneling method for a mobile terminal, comprising:
at a first device driver connected to a visit network, sensing a packet tunneled to an interface connected to the visit network;
at the first device driver, decapsulating a packet without transmitting the packet to a first IP end that is an upper layer of the first device driver and transmitting the decapsulated packet to a second driver; and
at the second driver, transmitting a packet to a second IP end that is an upper layer of the second driver.

2. The tunneling method of claim 1, wherein in the decapsulating of the packet, a header is removed if the packet is an IP-in-IP type packet.

3. The tunneling method of claim 1, wherein in the decapsulating of the packet, the packet is decoded through security association if the packet is an IP security protocol type packet.

4. A tunneling method for a mobile terminal comprising:
at a second device driver with a home address is mapped, receiving an IP packet using a home address;
at the second device driver, transferring the received packet to a first device driver mapped to a current tunneling end point; and
at the first driver, encapsulating the received packet and transmitting the encapsulated packet to an interface that is a lower layer of the first driver.

5. The tunneling method of claim 4, wherein in the encapsulating of the received packet, a header is added if the packet is an IP-in-IP type.

6. The tunneling method of claim 4, wherein in the encapsulating of the received packet, a packet is encoded through security association if a packet is an IP security protocol type.
